(19) United States
(12) Patent Application Publication
(10) Pub. No.: US 2009/0287515 A1
(43) Pub. Date: Nov. 19, 2009

(54) Monetization of Offline-Interface Events Operating on Ads Distributed Through Advertising Networks

(76) Inventors: Satish Mehta, Fremont, CA (US); Srinivas Margasahavam, San Jose, CA (US)

Correspondence Address: STATTLER - SUH PC, 60 SOUTH MARKET STREET, SUITE 480, SAN JOSE, CA, 95113, US

(21) Appl. No.: 12/121,163

(22) Filed: May 15, 2008

(51) Int. Cl. G06Q 30/00; G06Q 10/00; G06F 15/16; G06F 17/40

(52) U.S. Cl. 705/7; 709/201; 709/203

(57) ABSTRACT

Ads servers, clients, and networks serve and/or publish ads through online networks, then track offline-interface events that operate on the ads, and charge advertisers based on the offline-interface events. An enabling network includes an ads publishing module to request an ad from an ads serving module and publish the ad, a tracking module to track offline-interface events that operate on the published ad, and a billing module to charge an advertiser based on the offline-interface events.

### BACKGROUND OF THE INVENTION

1. Field of the Invention

Embodiments of the present invention relate to online advertising.

2. Art Background

There are many Internet-based systems that provide advertisements to content publishers. FIG. 1 illustrates one such ad serving arrangement. An ad moves from an advertiser 110 to an advertising target 140. The advertiser 110 provides an advertisement, along with certain criteria regarding its use, to the advertising distributor 120. The content publisher 130 requests ads from the advertising distributor 120 for publication along with content to the advertising target 140. Often the publisher 130 requests that ads be based on the nature of the content being published to the target 140.

As shown, the arrangement of FIG. 1 operates via an ads module 125. Both the publisher 130 and the ads module 125 communicate with the advertising distributor 130 and the advertising target 140. In typical arrangements, ads module 125 is uniquely identified to the content publisher 130 and inserted by the publisher in web pages that deliver publisher content. Under this scheme, publication of a web page containing an ads module 125 by publisher 130 prompts delivery of the ad to the advertising target 140 from the advertising distributor 120.

Advertiser 110 pays advertising distributor 120 for publication of the ads, and typically distributor 120 shares revenue from these payments with the content publisher 130. In current models, these payments are based on online user behavior that operates on the ads. For example, an advertising target 140 clicking on an advertisement or the ad being published to a web page based on a page load requested by the user. As illustrated by the “online ads behavior” arrow, an ads module tracks ad behavior occurring in an online context. One typical advertising model based on online ad behavior involves a discrete payment by an advertiser for every time a user clicks their advertisement. This is known as cost-per-click (CPC) advertising.

Another typical model based on online ad behavior involves payment by an advertiser for every time a user is shown their advertisement. Often the payment is bundled so that an advertiser makes a discrete payment for every 1000 publications (or impressions) of the ad. This is known as cost-per-impression (CPM) advertising.

### SUMMARY OF THE INVENTION

In one aspect, embodiments of the present invention relate to advertising networks their constituent servers. For example, consistent with some embodiments, a computer-implemented method of monetizing offline usage of advertisements distributed through an online advertising network comprises: serving an advertisement for publication to an advertising target through the network, tracking offline-interface events that operate on the advertisement, and charging an advertiser based on the offline-interface events. Preferably the advertiser charged is the advertiser originating the advertisement subject to the offline-interface events.

In another example, a computer server apparatus consistent with some embodiments is configured for distributing advertisements through an online advertising network and monetizing offline usage of the advertisements. An exemplary such server comprises an ads serving module configured to serve an advertisement to an advertising target through the network, a tracking module configured to track offline-interface events that operate on the advertisement, and a billing module configured to charge an advertiser based on the offline-interface events.

In another aspect, embodiments of the present invention relate to client elements of advertising networks. For example, consistent with some embodiments, a computer-implemented method for publishing advertisements from an online advertising network and tracking offline usage of the advertisements comprises: requesting an advertisement from the network, publishing the advertisement to an advertising target, and tracking offline-interface events that operate on the advertisement.

In another example consistent with the present invention, an advertising client apparatus for publishing advertisements from an online advertising network and tracking offline usage of the advertisements comprises an ads publishing module and a tracking module. The ads publishing module is configured to request an advertisement from the network and publish the advertisement to an advertising target. The tracking module is configured to track offline-interface events that operate on the advertisement.

In yet another aspect, embodiments of the invention relate to advertising systems configured to monetize offline usage of advertisements. An exemplary system comprises an ads publishing module, an ads serving module, a tracking module and a billing module. The ads publishing module is configured to request an advertisement for an advertising target and to publish the advertisement. The ads serving module configured to provide the advertisement to the advertising module. The tracking module configured to track offline-interface events that operate on the published advertisement. The billing module configured to receive information from the tracking module and to charge an advertiser based on the offline-interface events.

Preferably offline-interface events as used above include one or more of the following: printing an object comprising the advertisement, downloading an object comprising the advertisement, and saving an object comprising the advertisement.

Preferably client-side elements consistent with embodiments of the present invention are implemented through client side scripting, e.g. JavaScript.

### BRIEF DESCRIPTION OF THE DRAWINGS

FIG. 1 illustrates a prior art advertising serving arrangement.

FIG. 2 illustrates an advertising serving arrangement consistent with some embodiments of the present invention.

FIG. 3 illustrates an advertising serving arrangement consistent with some embodiments of the present invention.

FIG. 4 illustrates an advertising serving system consistent with some embodiments of the present invention.

FIG. 5 illustrates details of an advertising serving system consistent with some embodiments of the present invention.

FIG. 6 illustrates a system supporting an implementation of an advertising system consistent with the present invention.

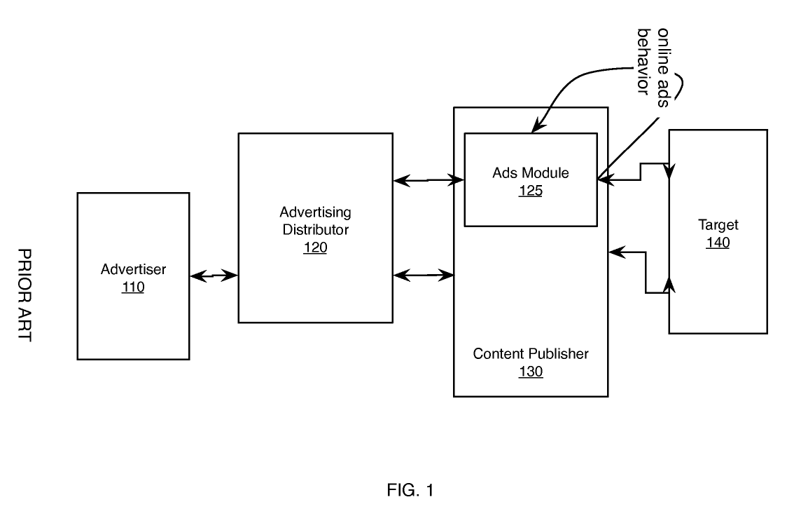

### DETAILED DESCRIPTION

Advertising

Internet users recognize typical advertisement serving schemes, wherein web pages include advertisements. Often, these advertisements are served from advertising networks. In some cases the ads served are based on web page content. In other cases the ads are not based on web page content.

Offline Interface

Embodiments of the present invention provide ways to charge advertisers, and pay publishers, for attention paid to the ad that doesn't occur within an online context. These embodiments do not actively track offline behavior, but instead track offline-interface events that operate on ads published through online networks.

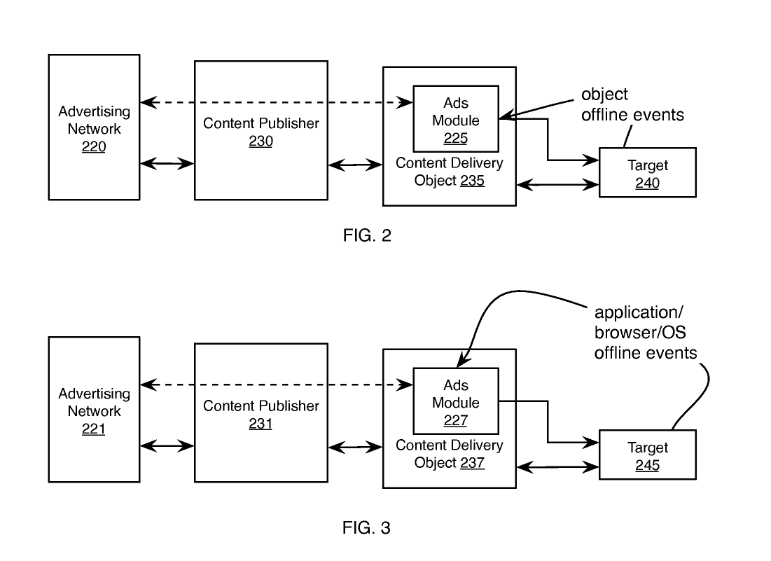

FIGS. 2 and 3 show ads serving arrangements consistent with some embodiments. In FIG. 2, an advertising network 220 provides ads to an advertising target 240. A relationship between the ad network 220 and a content publisher 230 permits the content publisher 230 to provide an ads module 225 within a content delivery unit 235 that is provided to ad target 240. An exemplary content delivery object 235 is a web page, but other such units include media objects.

Preferably ads module 225 is uniquely identified to the content publisher 230. Ads module 225 tracks both online ads behavior and offline interface events. Ads module 225 tracks offline interface events that operate on the content delivery object 235 containing the ads module 225, as illustrated by the “object offline events” arrow. Offline interface events remove the content and ads from the online context. For example, when the content delivery object 235 is a web page, an offline interface event is the user's saving the web page (and its attendant ads) or printing the web page (and its attendant ads. When the content delivery object 235 is a media file, offline interface events include downloading the media file (and its attendant ads). Preferably, advertising models based on offline interface events involve discrete payments from the advertiser for each event. Revenue from these payments is then shared with the content publisher 230. Terminology for such models might be cost-per-download (CPD), cost-per-save (CPS), and cost-per-print (CPP).

These advertising models apply to many situations. For example, many users download, print, or save static pages like an order submission page for an online purchase, a maps direction page, or a downloadable video they want to save.

In FIG. 3, an advertising network 221 provides ads to an advertising target 245. A relationship between the ad network 221 and a content publisher 231 permits the content publisher 230 to provide an ads module 227 within a content delivery unit 237 that is provided to ad target 245. Exemplary content delivery objects include a data structure delivered to a networked application, or the networked application itself.

Preferably ads module 227 is uniquely identified to the content publisher 231. Ads module 227 tracks both online ads behavior and offline interface events. Ads module 227 tracks offline interface events that operate on the ads published by the ads module 227 as illustrated by the “application/browser/OS offline events” arrow. In the context of networked applications and data delivered to such applications, elements within a browser or the application preferably track actions by the browser/application or by the OS that constitute offline interface events.

Offline interface events remove the content and ads from the online context. For example, when the content delivery object 237 is a news feed (containing advertisements inserted by ads module 227), an offline interface event is the user of a feed-reading application saving a story (and its attendant ads) or printing a story (and its attendant ads. OS-related interface events include taking screen-shots. Preferably, advertising models based on offline interface events involve discrete payments from the advertiser for each event. Revenue from these payments is then shared with the content publisher 231. Terminology for such models might be cost-per-save (CPS), cost-per-screen-shot (CPSS) and cost-per-print (CPP).

Network

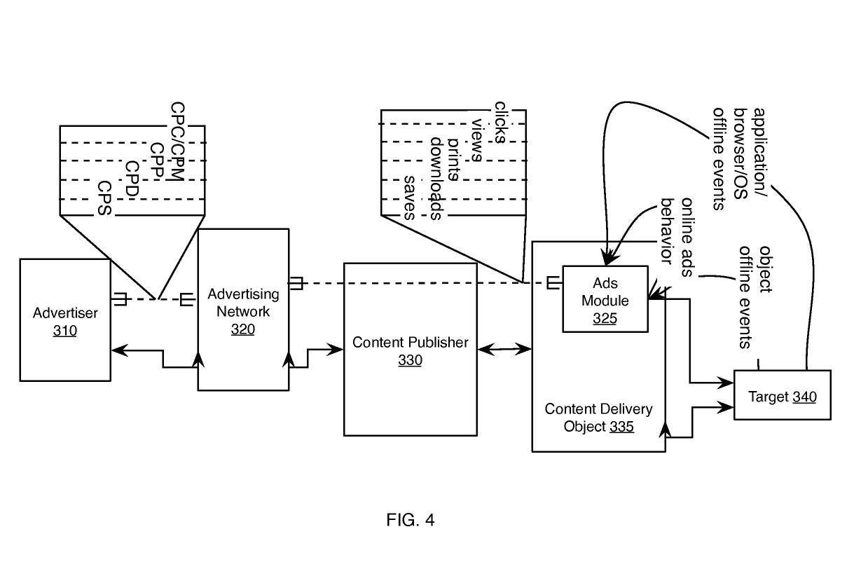

FIG. 4 illustrates an advertising serving system consistent with some embodiments of the present invention. Here, an advertising network 320 provides ads to an advertising target 340 from the advertiser 31 0. A relationship between the ad network 320 and a content publisher 330 permits the content publisher 330 to provide an ads module 325 within a content delivery unit 335 that is provided to ad target 340. An exemplary content delivery object 335 is a web page, but other such units include media objects, a data structure delivered to a networked application, or the networked application itself.

Preferably ads module 325 is uniquely identified to the content publisher 330. Ads module 325 tracks both online ads behavior and offline interface events. Ads module 325 tracks offline interface events that operate on the content delivery object 335 containing the ads module 325, as illustrated by the “object offline events” arrow. Ads module 325 also tracks offline interface events that operate on the ads published by the ads module 325 as illustrated by the “application/browser/OS offline events” arrow. In addition, as illustrated by the “online ads behavior” arrow, ads module 325 preferably tracks ad behavior occurring in an online context.

Offline interface events remove the content and ads from the online context. As illustrated, ads module 325 provides data on online context ad usage and offline events to the advertising network 320. Such data includes clicks on or views of ads as well as prints, downloads, and saves of the content object containing the ads.

Based on information from the ads module 325, advertising network 320 applies a variety of ad payment models to the advertiser 3 10. For a given ad these include CPM or CPC as well as CPP, CPD and CPS. The advertiser 310 pays according to the behavior and the applied ad models to the advertising network 320; revenue from these payments is then shared with the content publisher 330.

Web Pages

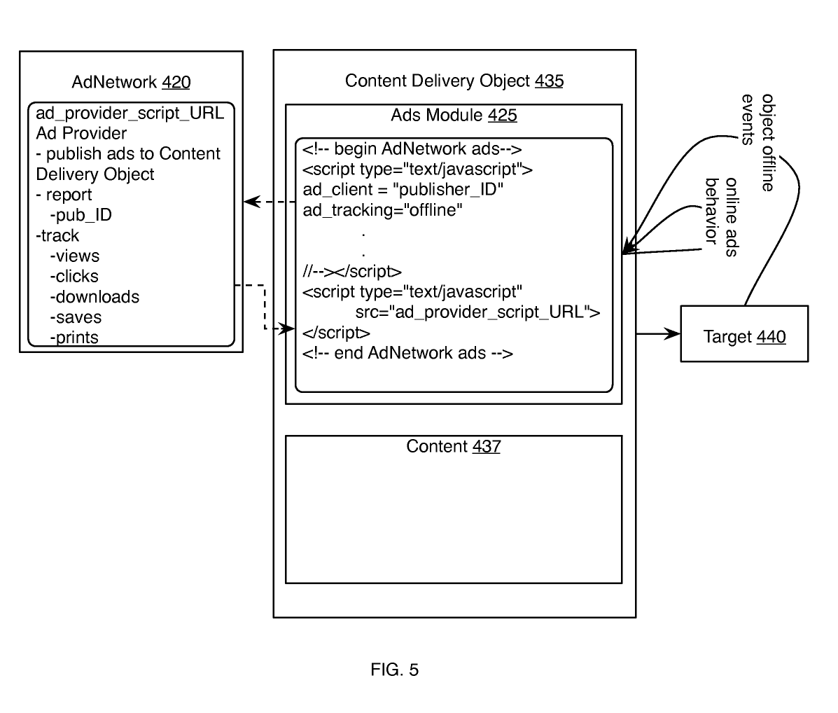

FIG. 5 illustrates details of a web page based advertising system consistent with some embodiments of the present invention. The system includes ad network 420, content delivery object 435 and ad target 440.

Content delivery object 435 includes content 437 and ads module 425. Content 437 and ads from the ads module 435 are presented to the target 440. As shown, ad network 420 and content delivery object 435 communicate though ads module 425, which includes a client-side script. Upon request by target 440 of content delivery object 435, content delivery object 437 delivers both content 437 and ads module 425 to target 440. Ads module 425 sets various values, notably values related to the unique identifier of the content publisher (not shown) “publisher_ID” and to offline-interface tracking “offline”. Then, the ads module 425 retrieves a script from the ad network 420, and executes the script housed at “ad_provider_script_URL” to display the ads to the target 440.

Ad network 420 includes a script housed at “ad_provider_script_URL” that publishes ads to the content delivery object from which it is called, e.g. content delivery object 435 in FIG. 5, then reports the publisher_ID, and tracks views, clicks, downloads, saves, and prints of the content delivery object by the target 440. The tracking of online events is illustrated by the “online ads behavior” arrow, while the tracking of offline events is illustrated by the “object offline events” arrow.

This web-page implementation leverages current advertising techniques, where a code snippet, known as a “beacon code” provided to a publisher identifies the publisher, sets publisher-chosen parameters, displays the ads, and tracks ad usage. Preferably embodiments of the present invention implemented in existing ad networks are implemented alongside current techniques to leverage the existing infrastructure and relationships with existing ad publishers. However stand-alone implementations are considered as well.

Implementation

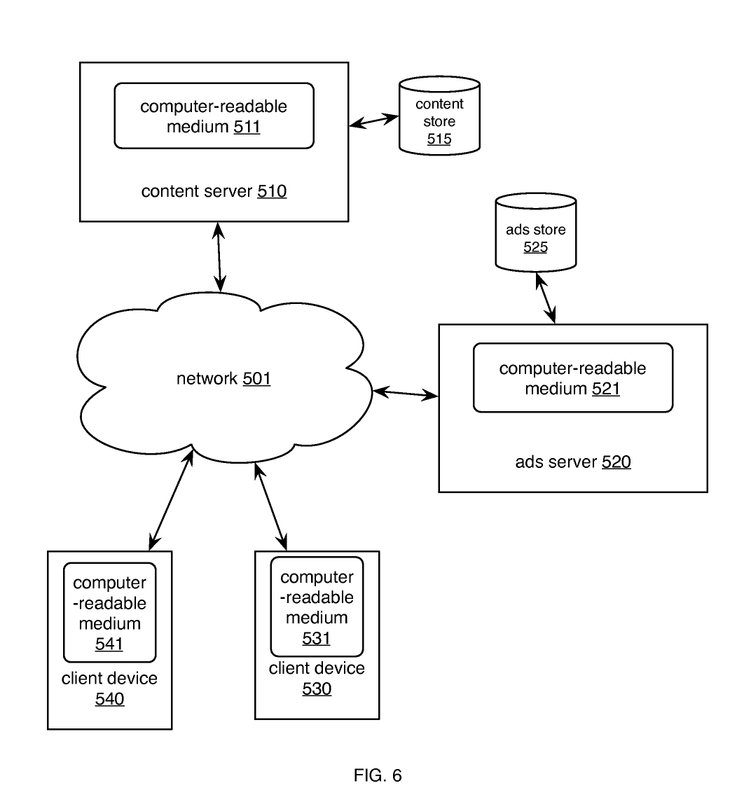

FIG. 6 illustrates a system supporting implementations of embodiments of the present invention. The system includes a content server 510, and ads server 520, client devices 530 and 540, and a network 501. Preferably network 501 is the Internet.

Server and client devices 510, 520, 530 and 540 include computer-readable media, 511, 521, 531, and 541 respectively, such as random access memory. The devices 510, 520, 530 and 540 execute instructions stored in media 511, 521, 531, and 540. Servers 510 and 520 additionally us content store 515 and ads store 525 respectively. Likely client devices include personal computers, mobile devices, and networked content players. Servers may be implemented as networks of computer processors or as single devices.

Client users communicate over network 501 via client devices 530 and 540 with each other and with other users of the network 501, including content server 510 and ads server 520. Client users preferably include advertisers and advertising targets. An ad network preferably comprises the ads server 520. The content publisher preferably employs a content server 510.

Advantages

Embodiments of the present invention monetize behavior that is already occurring and which provides value to the advertiser. Preferably CPD/CPS/CPP pricing is determined via market conditions and prior agreement between an advertiser and the advertising network.

Although the present invention has been described in terms of specific exemplary embodiments, it will be appreciated that various modifications and alterations might be made by those skilled in the art without departing from the spirit and scope of the invention. The scope of the invention is not limited to the exemplary embodiments described and should be ascertained by inspecting the appended claims.

What is claimed is:

1. A computer-implemented method of monetizing offline usage of advertisements distributed through an online advertising network, comprising:
a. serving an advertisement for publication to an advertising target through the network;
b. tracking offline-interface events that operate on the advertisement; and
c. charging an advertiser based on the offline-interface events.

2. The computer-implemented method of claim 1, wherein offline-interface events include one or more the following: printing an object comprising the advertisement, downloading an object comprising the advertisement, and saving an object comprising the advertisement.

3. The computer-implemented method of claim 1, wherein serving is performed in response to a request from a client-side script.

4. The computer-implemented method of claim 1, wherein tracking is based on data obtained from a client-side script.

5. The computer-implemented method of claim 1, wherein a publisher of the advertisement is paid a portion of the fee charged to the advertiser.

6. The computer-implemented method of claim 1, wherein an identity of the publisher of the advertisement is obtained from a client side script.

7. A computer server apparatus implementing the method of claim 1, wherein serving is performed by an ads serving module of the computer server apparatus.

8. The computer server apparatus of claim 7, wherein tracking is performed by a tracking module of the computer server apparatus.

9. The computer server apparatus of claim 7, wherein charging an advertiser is performed by a billing module of the computer server apparatus.

10. A computer-implemented method for publishing advertisements from an online advertising network and tracking offline usage of the advertisements, comprising:
a. requesting an advertisement from the network;
b. publishing the advertisement to an advertising target; and
c. tracking offline-interface events that operate on the advertisement.

11. The computer-implemented method of claim 10, wherein offline-interface events include the following: printing an object comprising the advertisement, downloading an object comprising the advertisement, and saving an object comprising the advertisement.

12. An advertising client apparatus implementing the method of claim 10, wherein requesting an advertisement is performed by an ads publishing module of the client apparatus.

13. The advertising client apparatus of claim 12, wherein publishing the advertisement to an advertising target is performed by the ads publishing module.

14. The advertising client apparatus of claim 12, wherein the tracking is performed by a tracking module of the client apparatus.

15. The advertising client apparatus of claim 12 implemented in a client-side script.

16. The advertising client apparatus of claim 15, wherein the client-side script communicates an identity of a publisher of the advertisement to the advertising network.

17. An advertising network configured to monetize offline usage of advertisements, comprising:
a. an ads publishing module configured to request an advertisement for an advertising target and to publish the advertisement;
b. an ads serving module configured to provide the advertisement to the advertising module;
c. a tracking module configured to track offline-interface events that operate on the published advertisement; and
d. a billing module configured to receive information from the tracking module and to charge an advertiser based on the offline-interface events.

18. The advertising network of claim 17, wherein offline-interface events include the following: printing an object comprising the advertisement, downloading an object comprising the advertisement, and saving an object comprising the advertisement.
